(19) United States
(12) Patent Application Publication
(10) Pub. No.: US 2013/0090894 A1
(43) Pub. Date: Apr. 11, 2013

(54) SYSTEM AND METHOD FOR COMPUTER-AIDED USER-SPECIFIC DESIGN

(71) Applicants: Tomer DIKERMAN, Tel-Aviv (IL); Nir Levie, Tel-Aviv (IL); Israel Bitton, Tel-Aviv (IL)

(72) Inventors: Tomer DIKERMAN, Tel-Aviv (IL); Nir Levie, Tel-Aviv (IL); Israel Bitton, Tel-Aviv (IL)

(21) Appl. No.: 13/270,409

(22) Filed: Oct. 11, 2011

(51) Int. Cl. G06F 17/50

(52) U.S. Cl. 703/1

(57) ABSTRACT

A system and a method for designing a unique product based on a computer aided design system and a parametric design tool, automatically preparing a product file, in accordance with the specific design created by the user, and sending a self designed product for manufacturing is provided.

### BACKGROUND OF THE INVENTION

Most products may be divided in to two main groups: mass production products and custom made products. Naturally, most of the products purchased by most customers are mass production products. Thus, a customer has limited choices and is restricted to the designs dictated by the manufacturer of the mass production products.

US Patent Publication No. 2005/0027553 (US 2005/0027553) discloses a system and apparatus for semi-custom furniture design. However, US 2005/0027553 does not allow a user to completely and fully design his product but rather to choose to replace specific parts of a piece of furniture with another part provided by the system. Furthermore, US 2005/0027553 is limited to the semi-custom design of furniture.

The present invention provides a comprehensive design system and method that overcome the disadvantages of the prior art systems and method.

### FIELD OF THE INVENTION

The present invention relates generally to computer aided design and preparation for manufacturing tools for user-specific design of “one of a kind” products. More specifically, a system and a method for designing a unique product based on a computer aided design system and a parametric design tool, automatically preparing a product file, in accordance with the specific design created by the user, and sending a self designed product for manufacturing is provided.

### SUMMARY OF THE INVENTION

The present invention provides a system and a method for designing a unique product based on a computer aided design system and a parametric design tool, automatically preparing a product file, in accordance with the specific design created by the user, and sending a self designed product for manufacturing.

A system and method for designing a custom made product, preparing a product file and sending for production. The system and method are adapted to allow both professional designers and amateurs having no previous knowledge and experience to design and send for production a personally designed product.

Systems and methods according to the present invention utilize different data structures for different products and manufacture method. The System according to some embodiments of the present invention is based on defining each type of product in a modular and parametric manner. According to one embodiment of the present invention, multiple participants design is disclosed, allowing a user to design a product by combining elements designed by more than one user.

According to a method of the present invention, a user may initiate a designing session, for designing a product or products or parts thereof. When the design of a product is completed, the user may create a product file for the completed product, select a manufacturer and send the product file to the manufacturer for production. The product file may be a set of digital instructions and data for operating a machined production process. This product file may be prepared as a ‘direct digital manufacturing’ file according to the file-to-manufacture approach.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1E are flowcharts of design, presentation and order methods according to embodiments of the present invention;

FIG. 2 is an illustration of a Graphical User Interface (GUI) having a 3 Dimensional illustration capabilities according to an embodiment of the present invention;

FIG. 3 is an illustration of a GUI having a 2 Dimensional illustration capabilities according to an embodiment of the present invention;

FIG. 4 is a schematic illustration of a parametric design tool having 5 controllable parameters, in an idle mode;

FIG. 5A is a schematic illustration of a parametric design tool having 5 controllable parameters, in active mode according to one embodiment of the present invention;

FIG. 5B is a schematic illustration of a parametric design tool having 2 controllable parameters, in active mode according to one embodiment of the present invention;

FIG. 5C is a schematic illustration of changing a part's model using the design tool of FIG. 5A;

FIG. 5D is another schematic illustration of changing a part's model using the design tool of FIG. 5A, according to another embodiment of the present invention;

FIG. 6 is a schematic illustration of a design tool for replacing parts of a designed item according to an embodiment of the present invention;

FIG. 6A is a schematic illustration of replacing a part's model using the design tool of FIG. 6.

FIG. 7 is a schematic illustration of a part copy and paste tool according to embodiments of the present invention;

FIG. 8 is an exemplary illustration of modular composition of a piece of furniture, corresponding to one possible structure, according to one embodiment of the present invention;

FIG. 9 is a schematic illustration of an assembly scheme of a custom designed piece of furniture according to an embodiment of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

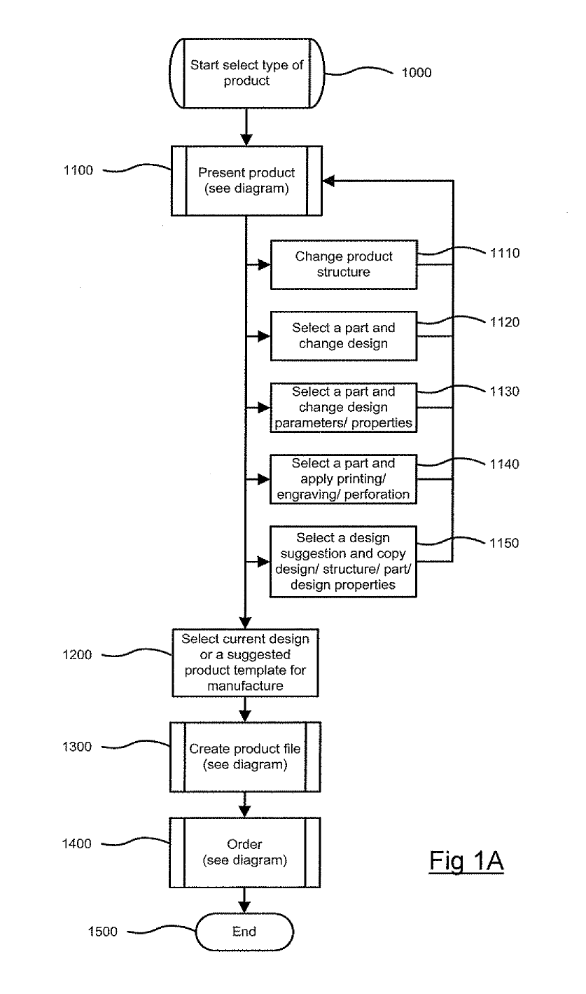

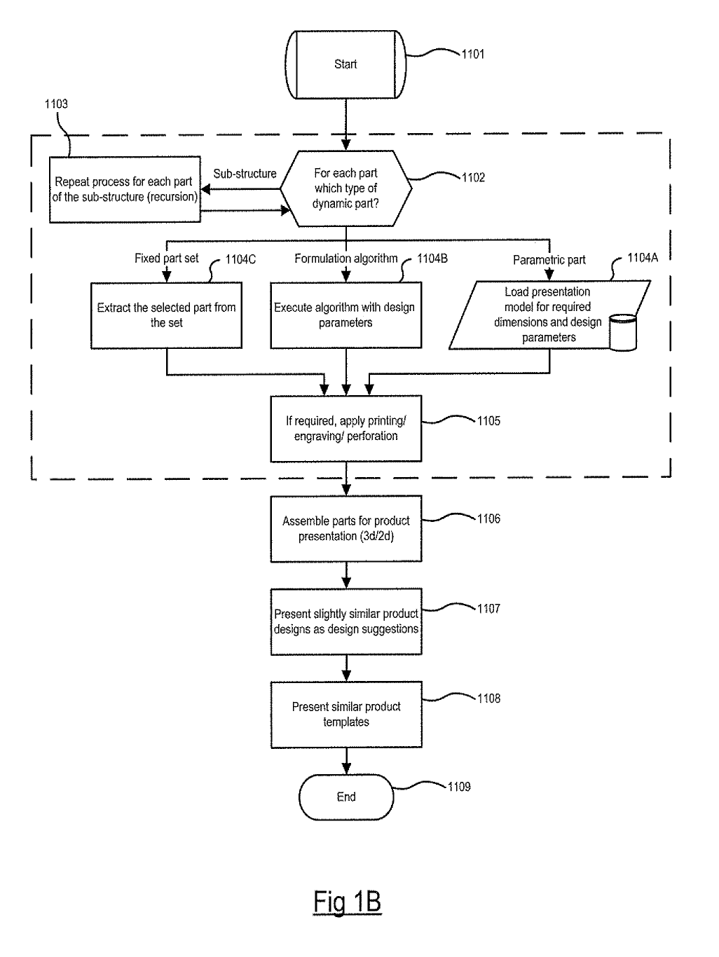

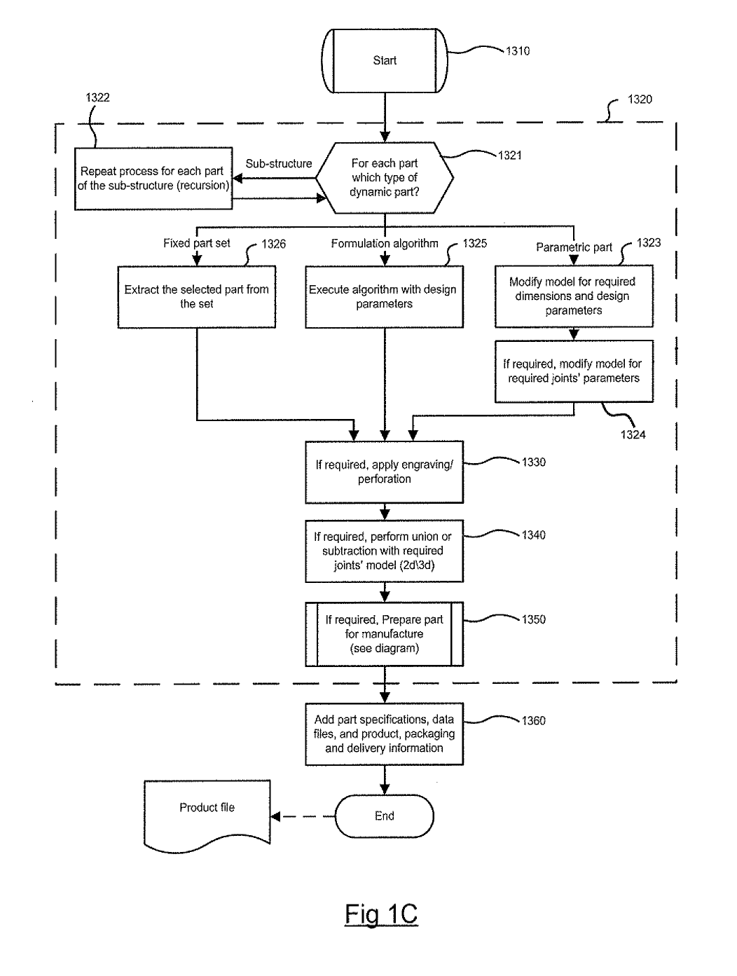

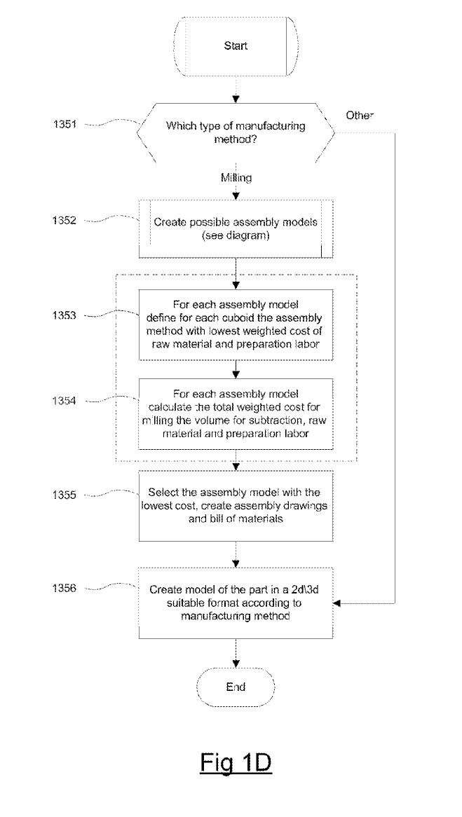

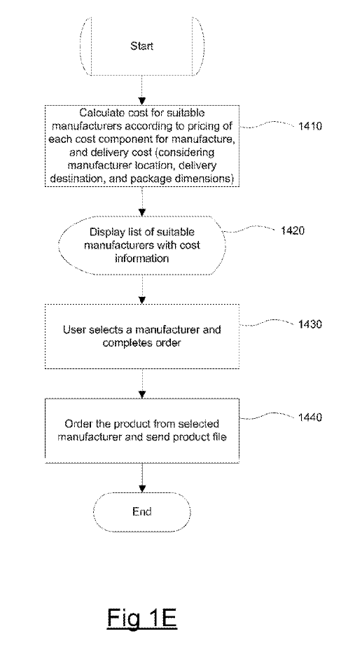

The method according to one embodiment of the present invention will be further detailed with reference to FIGS. 1A-1F, which are flowcharts of methods for computer aided personal design of a product and for preparation for manufacture thereof, according to some embodiment of the present invention.

As may be seen in FIG. 1A, a user may start a design process of a user specific designed product, by selecting a type of product to be designed and manufactured [block 1000]. According to some embodiments of the present invention, the product may be selected from a variety of different products and goods, such as furniture, closing, jewelry and fashion accessories, home appliances, and the like.

According to some embodiments of the present invention, upon selection of a type of product to be designed, an illustration of a product from the selected type is presented [block 1100]. The illustration may be 3 dimensional or 2 dimensional. Additionally or alternatively, the illustrated product may be a random selection of a product design from a database of basic designs available.

According to some embodiments of the present invention, the selection of the basic design for the selected type of product may be based on criteria defined by the user, such as the price range of the product, a desired design style, etc.

If the suggested design is satisfactory to the user, the user may send a production file of the product to manufacturer [block 1200]. If however, the suggested design is not satisfactory to the user, the user may modify and redesign the product.

After a type of product has been selected, the user may change the structure of the product [block 1110] by either selecting a different structure for the same product type which better complies with the user's requirements, by modifying different parameters and properties of the product structure, or by adding parts to or removing parts from the product. According to some embodiments the product may be produced from a single raw material bulk.

For example, according to one embodiment of the present invention, if the user selects to design a tea table, the system may select to present an oval tea table having 3 legs. The system may further present alternative structures of tea tables with similar properties as of the presented product. The user may change the shape of the table to be circular or add an additional leg. Alternatively the user may select a circular tea table for the alternative structures presented by the system.

According to some embodiments of the present invention, in addition or alternatively, the user may choose to design specific part(s) of the product [block 1120]. The design of a part of a product may be either by replacement of a part with another part or by changing properties and/or parameters of a selected part.

According to some embodiments of the present invention, each type of product may have a list of part types associated with it which may be designed or redesigned by the user. These parts are referred to as dynamic parts.

According to some embodiments of the present invention, each part may be designed individually by the user. The designing or redesigning process may be a parametric design process (i.e. redesigning a part by changing different parameters of the part such as the dimensions, curvatures, connectors etc.), a part formation algorithm process in which a part's model is created in real time based on design parameters and input from the user, and part set design [block 1130].

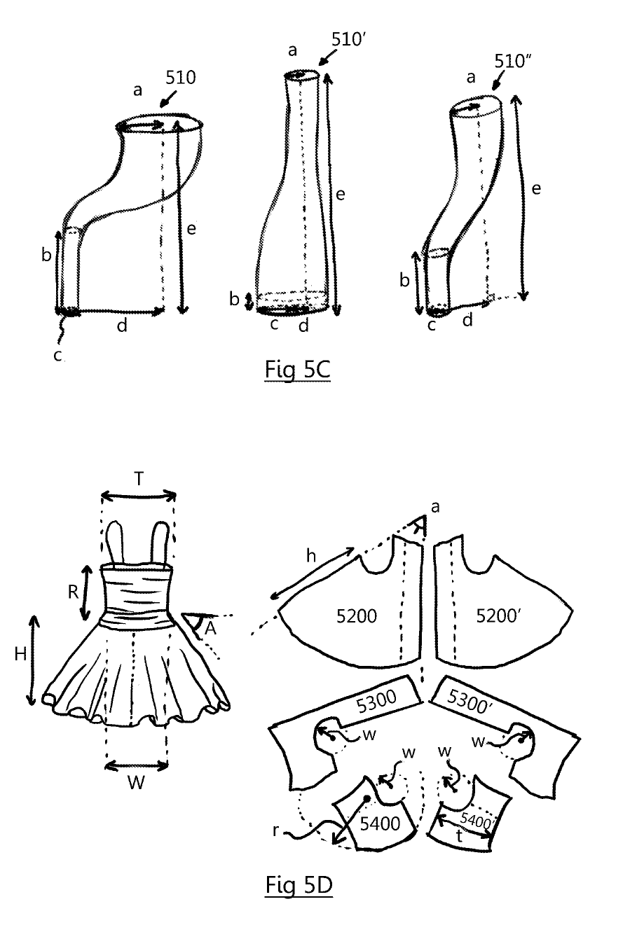

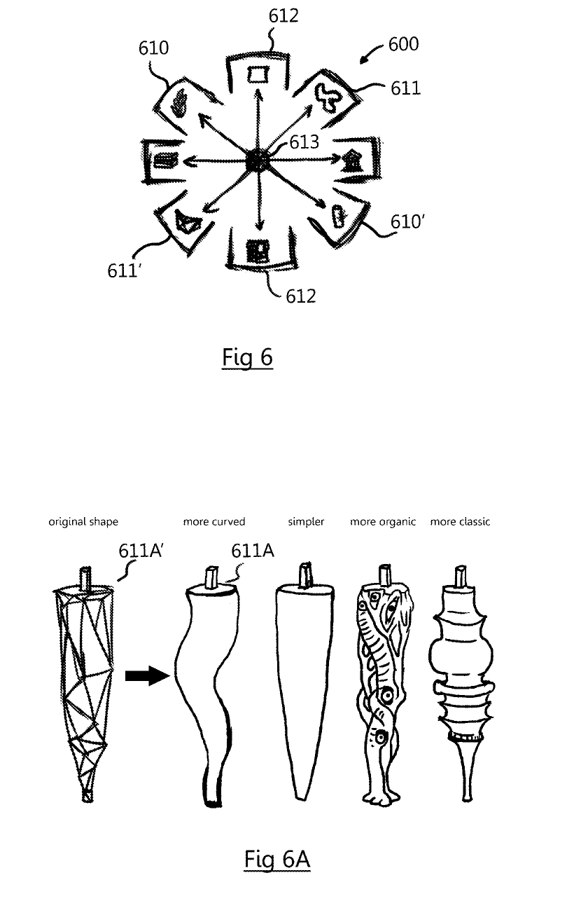

If the selected part is a parametric part, then the user may modify the selected part's design by changing dimensions and design parameters. For example, if the selected part is a leg of a table, which is a parametric part, the user may choose to adjust and change different parameters of the leg such as the radius of the leg at different sections along the leg, the length of the leg, curvature, angle and/or any other parameter defining the design of the leg. A more detailed description of a parametric part design process according to some embodiments of the present invention will be provided hereinafter when referring to FIGS. 5A-5C, 6 and 6A.

According to some embodiments of the present invention, each parameter of a parametric part may be changed within a predefined range and in predefined intervals. For instance, when the parametric part is a leg of a table, the length of the leg may be in the range of 30 cm-110 cm and may be changed in intervals of 5 cm. Since the variations in each parameter of a part are limited to a predefined number, 3D and/or 2D models of the part in all available designs may be saved in advance. Thus, when a user changes a parameter, or a number of parameters, a model of the part is replaced with a modified model of the part. In a similar manner, some predefined properties of a part may be changed by the user. The changeable properties may be design characteristics, such as material, color, glossy or matte finish and the like, between which the user may select the required value.

According to yet other embodiments of the present invention, when the selected part is a product of a formation algorithm, a model of the designed part may be created in real time by running an algorithm on input (such as product definitions, text to be added, etc.) received from the user. For example, changing one parameter of a dress designed by a user, may result in rerunning the algorithm on the input value/selection received from the user (including the revised parameter) and recreating in real time a model of the redesigned dress.

When the selected part is from a fixed part set, the design of the part may be performed by replacing one part with another part from the fixed part set.

According to some embodiments of the present invention, a user may add printing on the part's surface and/or engraving of the part's surface and/or perforation to a single part or a plurality of parts [block 1140].

According to some embodiments of the present invention, when a design of a part or a product is changed, the 3D or 2D illustration of the product with the altered part may be presented [block 1100]. According to some embodiments the change may be presented to the user to enable dynamic feedback and immediate reflection of the effect of the change made.

Reference is now made to FIG. 1B which is a flowchart of a method for presenting a product to the user. When a model of a product or a part should be presented to the user, a preparation for presentation process is initiated [block 1101]. As may be seen in FIG. 1A, a preparation for presentation process may be initiated upon selection of a product type to be designed and/or after each change in the design of a structure or a part [block 1100 in FIG. 1A].

Each product may be assembled from a plurality of parts. Each part may be either a dynamic part (i.e. a part that may be designed or redesigned by a user) or a fixed part (i.e. a part that may not be modified but may be replaced by another compatible part). Dynamic parts may be of different types. According to some embodiments of the present invention, there may be two categories of dynamic parts: parametric parts and formation algorithm parts.

After a preparation for presentation process is initiated each part of a product to be presented is identified and categorized according to its type [block 1102]. If a part to be presented is a sub-structure, each part of the sub-structure may be subject to the preparation for presentation process [block 1103].

After the type of each part has been determined, a presentation model of each part is created. According to some embodiments of the present invention, the model of each part may be created in a different manner, according to the type of the part. If the part is a product of formation algorithm, an algorithm is executed on the parameters and requirements provided by the user. The output of the algorithm may be a 2D or 3D model of the part which is created in real time according to the input received from the user [block 1104B]. For example, if the part being a product of formation algorithm is a surface of a table, in the design process, the user may determine its shape, its dimensions, its color and finish and the like. After all required parameters and requirements have been provided by the user, the formation algorithm may create a model of the part, according to the input from the user.

According to some embodiments of the present invention, the model of each parametric part is saved in a database in advance and is not created in real time. As described with reference to FIG. 1A above, each parameter of a parametric part may be changed within a predefined range and in predefined intervals. For instance, when the parametric part is a leg of a table, the length of the leg may be in the range of 30 cm-110 cm and may be changed in intervals of 5 cm. Since the variations in each parameter of a part are limited to a predefined number, 3D and/or 2D models of the part in all available designs may be saved in advance. Thus, when a user changes a parameter, or a number of parameters, a model of the part is replaced with another model of the part after modification. When a parametric part is required for presentation the pre-saved model is loaded from the database [block 1104A]. It would be appreciated that the saved models of each parametric part in all available variations thereof, may be only presentation models and not production models. In such instances, the presentation model may be in low resolution and having only information required for presentation purposes. A high resolution production model may not be saved in the database and may be created only when the design process has ended and the final product is sent for manufacturing.

Fixed set parts are parts that their design may not be modified and amended by the user but they may be replaced with another part from a predefined set of parts. When the presentation of a fixed set part is required (e.g. upon initialization of the design process or upon replacement of a fixed set part) the model of the part is extracted from a database in which the models (in 2D and/or in 3D) of all parts in a set of parts are saved [block 1104C].

After models of all parts and structures have been created, printing, engraving and/or perforation may be added to any part model as may be desired [block 1105]. Block 1108 describes a step at which product templates similar to that just defined by the user are presented to the user. The template may include product information such as product picture, product price (per producer) and product production variations and instructions. The printing, engraving and/or perforation may be designed by the user in the design process [FIG. 1A block 1140].

FIG. 1C is a schematic illustration of a method for creating a product file according to one embodiment of the present invention. The method may start after user completes the design process and is interested in manufacturing the product [block 1310]. The creation of a product file begins with the production of manufacturing product models for each part and structure. This step of creating a manufacturing model of the product [block 1320] is similar to the method described with reference to FIG. 1B above. However, it would be appreciated by those skilled in the art that the model of each part created for manufacturing the part is in much higher resolution and contains more details such as provision for connectors, adaptation to the selected raw material and adaptation for the selected finishing material and method.

According to one embodiment of the present invention, each part of a product is identified and categorized according to its type [block 1321]. If a part is a sub-structure, each part of the sub-structure may go through the create model for product file process [block 1322].

After the type of each part has been determined, a model for product file of each part is created. According to some embodiments of the present invention, the model of each part may be created in a different manner, according to, for example, the type of the part. If the part is a product of formation algorithm, an algorithm is executed on the parameters and requirements provided by the user. The output of the algorithm is a 2D or 3D model of the part which is created according to the input received from the user [block 1325].

According to some embodiments of the present invention, when a model of a parametric part is required for product file, a pre-saved model may be loaded from a database. According to other embodiments of the present invention, the pre-saved model of a parametric part may be modified to include all required information and details such as dimensions and design parameters [block 1323]. A high resolution product file model of each parametric part may not be saved in the database and may be created when the design process has ended and before the final product is sent for manufacturing. According to some embodiments of the present invention, the high resolution model for the product file may be created by applying a formation algorithm on the design parameters selected by the user in the design process. It would be appreciated by those skilled in the art that according to some embodiments, the same algorithm may be used for parametric parts and for formation algorithm parts.

After a model of a parametric part has been created, the model may require further adjustment and/or modification in order to fit required connections/connectors [block 1324]. The model may be modified to allow adding a connector thereto. The resulting file may contain more details such as provision for connectors, adaptation to the selected raw material and adaptation for the selected finishing material and method.

According to some embodiments of the present invention, the product file model of fixed set parts is pre-saved and may be extracted from a database [block 1326].

After models of all parts and structures have been created, printing, engraving and/or perforation may be added to each part model [block 1330].

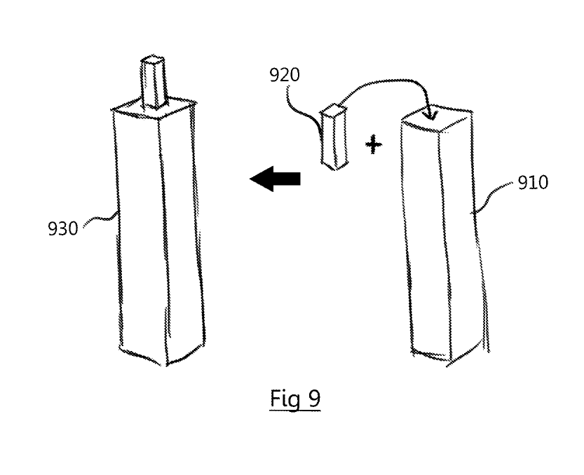

According to some embodiments, if connectors (i.e. connecting elements being part of a product element) are required in order to connect the selected part with another part of the product, connectors may be added, attached or created. This may be done by union or subtraction of a 3D or 2D model of the connector, to or from the 3D or 2D model of the part [block 1340]. See the description of FIG. 9 for more details of connector production.

After product file models of all parts have been created and connectors have been added as required, each part may be prepared for manufacture [block 1350]. The preparation for manufacture is described with reference to FIG. 1D hereinafter.

Adding part specifications, data files, and product, packaging and delivery information may complete the preparation of a product file [block 1360]. A complete product file may comprise, for example, the following data: general list of content, list of figures (e.g. parts and product models in 2D and/or 3D), list of attached files, manufacturers details, manufacturer warranty definitions, customer information and delivery information, product description, different views of the product including dimensions (e.g. top view, bottom view, perspective view, orthographic view and the like), product parts list, bill of materials, bill of quantities for production (for raw materials, finishing materials and off the shelf parts), production information, such as required raw materials, required manufacturing technologies, manufacturing diagrams, manufacturing and finishing instructions, assembly instructions and diagrams and packaging instructions and diagrams, production files (drawings in 2D/3D) for manual/machine production, in various production technologies such as LASER cutting, milling/machining, Computed Numerically Controlled (CNC), digital printing, etc. It would be appreciated by those skilled in the art that other or additional information may be included in a product file. It would be further appreciated that all of the information required for a product file may be received from the user or may be pre-stored with respect to each part, product or structure, or may be created during the design and preparation for manufacture processes as described above. For example, the figures of each part may be created as described with reference to FIGS. 1B and 1C above, delivery information may be received by the user, and required manufacturing technologies information may be pre-stored with respect to a part model or a specific material, or property of a part. For example, if the selected part is a metal part, metal processing technologies must be available to the manufacturer in order to produce the required part. The manufacturer details may also be pre-stored and may be added to a product file if the manufacturer is found suitable for the required manufacturing process (e.g. having all required machinery and equipment required in order to manufacture all part of a product, geographically close to delivery destination and the like).

Reference is now made to FIG. 1D of the application, which is a flowchart of a method for preparing a part for manufacture according to one embodiment of the present invention. As may be seen if FIG. 1D, the manufacturing method of each part may be different. Thus, the manufacturing method of each part should be determined [block 1351]. If the part is manufactured by milling or engraving, creating an assembly model may be required [block 1352]. The creation of an assembly model may be done in any method known in the art.

For each assembly model, defining assembly model, a cuboid with the lowest weighted cost of raw material and preparation labor [block 1354].

Reference is now made to FIG. 1E which is a flowchart of a method for ordering a product according to an embodiment of the present invention. After completion of design process and preparation for manufacturing process, the system may review a pre-stored list of manufacturers available for the manufacturing of the designed product and calculate the cost for suitable manufacturers according to pricing of each cost component for manufacture, and delivery costs. According to some embodiments of the present invention, the delivery costs may be calculated according to manufacturer's geographical location, delivery destination, package dimensions, delivery requirements and the like [block 1410]. After a list of suitable manufacturers have been created and a cost estimation for manufacturing and delivery of product have been calculated for each manufacturer, the manufacturers and costs information may be presented to the user [block 1420].

User may then select a manufacturer and complete any required and missing information [block 1430]. According to some embodiments of the present invention, each manufacturer may be rated by previous users, by price and warranty terms, and/or according to any other or additional evaluation parameter, and the ranking of each manufacturer may be presented together with the manufacturer's details and cost estimation.

After the manufacturer has been selected, the order may be completed and a product file may be sent to the selected manufacturer [block 1440].

It would be appreciated by those skilled in the art that the calculation of costs [block 1410] may be based on the type of product to be manufactured, the dimensions thereof, the materials from which it is manufactured, the manufacturing technology and process and the delivery costs. It would be further appreciated that other or additional factors may be considered in the calculation.

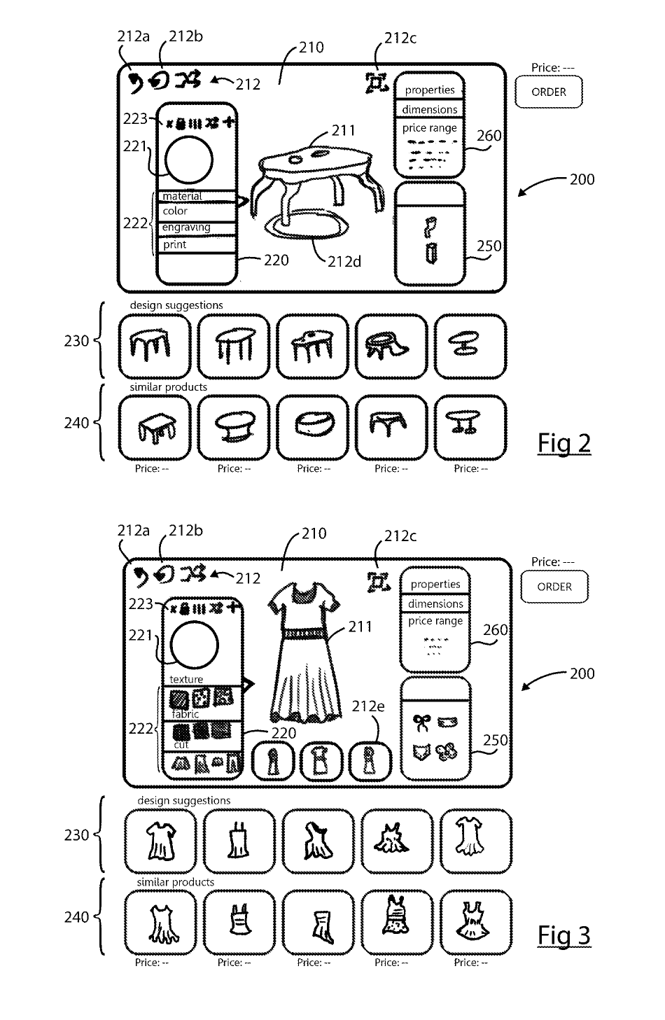

Reference is now made to FIGS. 2 and 3 which are illustrations of a Graphical User Interface (GUI) having a 2 Dimensional and 3 Dimensional illustration capabilities according to embodiments of the present invention. GUI 200 may be divided into a plurality of zones. According to one embodiment of the present invention, GUI 200 may comprise a 2D/3D illustration zone 210, a design tool zone 220, a product design suggestions zone 230, similar products for purchase 240, part design suggestions zone 250, and properties and dimensions window 260. It would be appreciated by those skilled in the art that additional or alternative tools and zones may be used. It would be further appreciated that some of the tools may be combined or separated, removed or disabled, as may be required according to the design process steps.

2D/3D illustration zone 210 may present an illustration of a selected product type 211, such as a piece of furniture or a dress. Illustration zone 210 may further comprise a view tool bar 212. The view tool bar 212 may comprise a undo button 212a, a reset button to go back to basic design 212b, a full screen view toggle button 212c, a rotation button 212d, switch views windows 212e and any other control button for controlling viewing options, as known in the art.

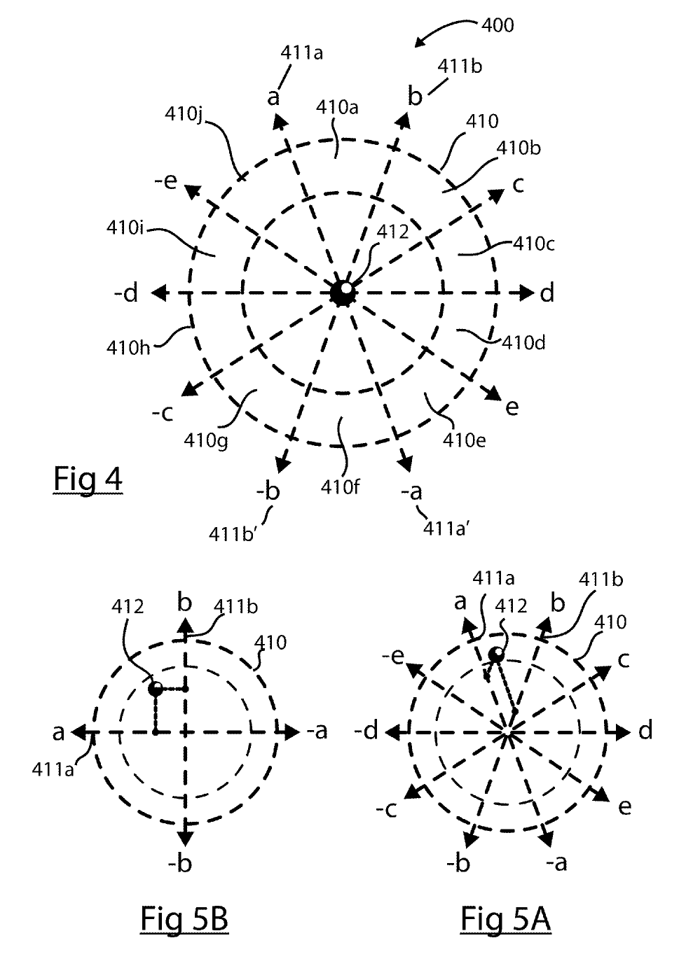

Parametric design tool zone 220 may comprise a design dial 221. Design dial 221 is further described with reference to FIGS. 4, 5A, 5B and 6.

Design tool zone 220 may further comprise properties control buttons 222 to control and modify different features of the designed part or product 211. Control buttons 222 may comprise material selection button or menu, color selection menu, engraving editor button, print editor button, texture selection button or menu, cut selection and any other property of designed product or part 211. Design suggestion area of the GUI may be operated using standard editing tools such as copy and paste, drag and drop, etc. Area 240 of the GUI may present similar products which may be selected based on similarity criteria and may enable purchase of the desired similar product.

Reference is now made to FIGS. 4, 5A, 5B, and 6 which are illustrations of different embodiments of a parametric design tool, and to FIGS. 5C and 5D which are exemplary illustrations of parametrically designed parts. As may be seen in FIG. 4 a parametric design tool 400 of a parametric part having five different adjustable parameters (a, b, c, d and e) is depicted.

According to one embodiment of the present invention, a design dial 410 may be divided into equal sections 410a, 410b, 410c, 410d, 410e, 410f, 410g, 410h, 410i and 410j.

Each section is contained between two vector arrows corresponding to each adjustable parameter a-e. As may be realized each adjustable parameter may have two vector arrows directed in opposite directions. First vector arrow 411 of an adjustable parameter a, b, c, d and e, is in a direction denoted “positive”. Second vector arrow 411′ of an adjustable parameter a, b, c, d and e, is in a direction denoted “negative”.

According to some embodiments of the present invention, design tool 400 may further comprise a parameter adjustment knob 412. As may be seen in FIG. 4, in an idle position, knob 412 may be located in the center of design dial 410, at the connection point of all vector arrows 411 and 411′.

As may be seen in FIGS. 5A and 5B when adjustment of parameters is required, knob 412 may be moved and relocated in any position within the bounds of design dial 410. Knob 412 may be placed along one of vector arrows 411 or 411′ to adjust only a single parameter by either increasing the value of the parameter (i.e. by placing knob 412 on vector arrow 411) or decreasing the value of the parameter (i.e. by placing knob 412 on vector arrow 411′).

Knob 412 may be placed between two neighboring vector arrows 411 and/or 411′, thus modifying the parameters represented by the neighboring vector arrows. For example, as illustrated in FIGS. 5A and 5B knob 412 may be placed between vector arrow 411a and vector arrow 411b, thus adjusting parameter a and parameter b. The adjustment of each parameter may be according to the projection of the location of knob 412 on each vector arrow 411a and 411b.

FIG. 5C illustrates a parametric part design after adjusting different parameters thereof. As may be seen in FIG. 5C, part 510 has five adjustable parameters a, b, c, d and e. For instance, parameter a may be the length of one radius of part 510, and parameter e may be the height of part 510. As illustrated in FIG. 5A placing knob 412 in a section of dial 410 located between two neighboring vector arrows may adjust both parameters controlled by the two vector arrows. As illustrated in FIG. 5D, dress 5100 may have, for example, five adjustable parameters H, R, T, W and A. According to some embodiments of the present invention, adjustment or modification of any of parameters H, R, T, W and A may change related parameters h, r, t, w and a in one or more parts of dress 5100. For example, parameter A may be the flaring angle of a bottom of a dress. Changing parameter A by shifting knob 412 (in FIG. 4) in one direction along a vector arrow 411 of design dial 410 (in FIG. 4), may result in increasing the flaring angle, by changing parameter a in parts 5200 and 5200′. According to some embodiments of the present invention, changes in a parameter may require changes in several parts. For example, when parameter W is a waistband length, changes thereto may require changes to curve radiuses w of parts 5300, 5300′, 5400 and 5400′. It would be appreciated by those skilled in the art that parametric design tool 400 (in FIG. 4) may be used to design dress 5100 as described with reference to FIGS. 5A-5C.

Reference is now made to FIG. 6 which is an illustration of a parametric design tool 600 according to yet another embodiment of the present invention. As may be seen in FIG. 6, instead of changing a parameter by setting its value, the characteristics of the part or product may be selected by selecting a substitute part, which may comprise parameters that better fit the user's needs.

According to one embodiment of the present invention, placing knob 613 along one of characteristics arrows 610, 611, 612, 610′, 611′, 612′ may change a single characteristic of the designed product or part. Placing knob 613 between two neighboring characteristics arrows 610, 611, 612, 610′, 611′, 612′ may change two characteristics of the designed part or product.

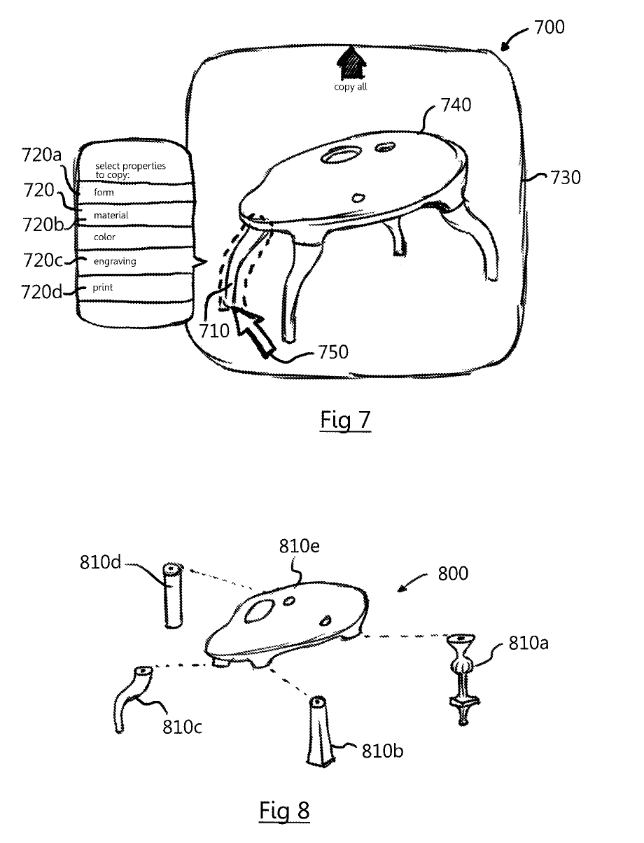

Reference is now made to FIG. 7 which is an illustration of a part copy and paste tool 700 according to one embodiment of the present invention. Copy and paste tool 700, may comprise a proposed product design window 730 and a select properties to copy menu 720. Menu 720 may allow a user to select one or more design properties of a part 710 of a proposed product 740, and copy the selected one or more properties of part 710 to a product (not shown) designed by the user. The selection of part 710 to be copied may be done in any method known in the art, such as by pointing with a cursor 750 on the selected part and pressing a selection button in a mouse or any other cursor control device known in the art.

According to some embodiments of the present invention, select properties to copy menu 720 may allow selection of a plurality of properties 720a, 720b, 720c and 720d, to be copied. According to some embodiments properties 720a, 720b, 720c and 720d may be the part design or one or more properties such as: form, material, color, texture, engraving, print etc. It would be appreciated by those skilled in the list of properties in menu 720 may change in accordance with the type of product from which the part is copied, the type of product to which the part is copied and the selected part properties. For example, when the product from which a part is selected is a garment, different textile properties may be presented in menu 720 as well as cut, embroidery etc. when, for instance, the selected product is a piece of jewelry, the properties in menu 720 may refer to type of gemstone, color of gemstone, size of gemstone, form, inlaying etc. It would be further appreciated that the entire proposed design 740 may be copied by the user or a property of an entire proposed design 740 may be selected and copied.

FIG. 8 is a schematic illustration of an assembly scheme of a custom designed product according to an embodiment of the present invention. User-designed product 800 may be assembled from a plurality of parts 810a, 810b, 810c, 810d and 810e. Each of parts 810a, 810b, 810c, 810d and 810e may be individually designed by the user or may be copied from a proposed design as described hereinabove with reference to FIG. 7.

According to some embodiments of the present invention, each part 810a, 810b, 810c, 810d and 810e may be designed by using the parametric design tool described hereinabove with reference to FIGS. 4, 5A, 5B and 6. It may be realized that some or even all of parts 810a, 810b, 810c, 810d and 810e may originate from the proposed design suggested upon selection of a product type at the beginning of the design process.

Reference is now made to FIG. 9 which is an illustration of modifying a part model 910 to comprise a required connector 920 by the union of a 3D model of part 910 and the 3D model of connector 920. The union/subtraction operation may result in a (unified) 3D model 930 of a part and a connector.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for designing a product, the method comprising:
selecting a product type from a list of product types;
presenting illustrations of products from the selected type of products;
selecting a product from said presented illustrations;
selecting a structure from a plurality of available structures of said product;
changing the design of structure of said product to fit a desired design; and
presenting an illustration of said product after said change of design.

2. The method according to claim 1 wherein said list of product types comprises at least one from a group comprising: furniture, clothing, jewelry, fashion accessories and home appliances.

3. The method according to claim 1 wherein changing the design of said product is performed by changing the structure of said product.

4. The method according to claim 1 wherein changing the design of said product is performed by changing at least one design parameter and at least one dimension of at least one part of said product.

5. The method according to claim 1 wherein changing the design of said product is performed by addition of at least one part to said product by selecting said at least one added part from a given set of parts.

6. The method according to claim 1 wherein changing the design of said product is performed by subtraction of at least one part from said product.

7. The method according to claim 1 wherein changing the design of said product comprises the following steps:
selecting a part of said product to be redesigned;
receiving design criteria from a user;
running a formation algorithm to create a model of said redesigned part; and
presenting a model of said product with said redesigned part.

8. The method according to claim 4 wherein said at least one design parameter can be changed in predefined intervals.

9. The method according to claim 1 further comprising applying engraving to said product.

10. The method according to claim 1 further comprising applying printing to said product.

11. The method according to claim 1 further comprising applying perforation to said product.

12. The method according to claim 1 further comprising suggesting existing products having similar designs.

13. The method according to claim 1 further comprising creating a product file including pre-stored product information, design information, user information and manufacturer information.

14. The method according to claim 13 wherein said design information comprises at least one of a group consisting: parts models, product structure information, design parameters values, text, engraving, perforation, finishing, color, texture and materials.

15. The method according to claim 1 wherein presenting an illustration of a product comprises:
creating a model of each part of said product;
assembling parts to create a model of said product; and
present said model of said product.

16. The method according to claim 15 wherein creating a model of each part of said product comprises:
determining the type of each part;
when the type of said part is a parametric part, obtain a pre-stored model of said part;
when said type of said part is a formation algorithm part, running an algorithm to create a model of said part based on information received from user and pre-stored information; and
when said type of said part is a fixed set part, obtain a pre-stored model of said part.

17. The method according to claim 16 further comprising modifying said model according to connectors to be added in order to connect parts of said product and according to raw material, finishing material and production method.

18. The method according to claim 1 wherein changing the design of said product is performed by changing said part's characteristic.

19. The method according to claim 4 wherein changing said at least one design parameter is performed by setting a location of a knob relative to parameter vector arrows on a design dial presentable to a user on a display unit to determine the values of said at least one design parameter.

20. The method according to claim 1 wherein changing the design of said product is performed by copying at least one design parameter of a first part of a first product and pasting said at least one design parameter to at least a second part of a second product.
